(19) United States
(12) Patent Application Publication
(10) Pub. No.: US 2025/0209310 A1
(43) Pub. Date: Jun. 26, 2025

(54) REAL-TIME MACHINE LEARNING TECHNIQUES FOR PROACTIVELY GENERATING AND ACTING ON USER-SPECIFIC ACTIVITY INSIGHTS

(71) Applicant: Optum, Inc., Minnetonka, MN (US)

(72) Inventors: Sankalita Saha, Saratoga, CA (US); Tanzeem Choudhury, New York, NY (US); Mohammod Mashfiqui Rabbi Shuvo, Bothell, WA (US)

(21) Appl. No.: 18/395,267

(22) Filed: Dec. 22, 2023

Related U.S. Application Data
(60) Provisional application No. 63/513,161, filed on Jul. 12, 2023.

(51) Int. Cl. G06N 3/0455; G06N 3/09

(52) U.S. Cl. CPC G06N 3/0455; G06N 3/09

(57) ABSTRACT

Various embodiments of the present disclosure provide real-time machine learning techniques for proactively generating and acting on user-specific activity insights. One technique may include generating a predictive activity sequence for a user that includes multiple activity predictions corresponding to multiple activity time segments within an evaluation time period. The technique may also include generating, based on the predictive activity sequence, a personalized activity sequence for the user that includes multiple activity subgoals corresponding to one or more activity time segments of the multiple activity time segments within the evaluation time period. The technique may also include identifying an occurrence of an activity time segment corresponding to an activity subgoal of the multiple activity subgoals. The technique may also include, in response to the occurrence of the activity time segment, providing data indicative of the activity subgoal.

### BACKGROUND

Various embodiments of the present disclosure address technical challenges related to sensor-based activity prediction and provisioning techniques. Despite the popularity of traditional goal tracking systems, such systems conventionally provide recommendations to users without consideration of a plan for achieving a goal or the practicality of achieving a goal. For example, some fitness applications track goal progress, but fail to provide a plan for achieving respective goals-let alone a plan that is feasible based on the personal routines of a user. By doing so, traditional goal tracking systems provide recommendations to users with limited ability to complete a goal which, in turn, limits the efficacy of traditional goal recommendation and tracking systems while adding stress to a user (e.g., by recommending an impractical goal, etc.) rather than improving a user's ability to achieve a goal.

Moreover, due to a lack of training data, among other technical challenges, traditional goal tracking systems are limited to generic goals or recommendations that are based on a population of users rather than specific factors tailored to each specific user within the population. This results in recommendations for tasks that may not be achievable and otherwise discourage users from attempting to complete a goal. Even if specific user factors are considered, traditional goal tracking systems lack timing mechanisms for proactively providing recommendations for achieving goals and instead surface recommendations at predetermined or static times without consideration of a user's schedule. For example, traditional goal tracking systems may retroactively notify a user that a goal has not been met (e.g., at the end of the day, etc.) rather than proactively providing personalized recommendations that result in completion of the goal. These limitations, among others, limit the efficacy, usability, and accessibility of traditional goal recommendation and tracking systems.

Various embodiments of the present disclosure make important contributions to traditional sensor-based activity prediction and provisioning techniques by addressing these technical challenges, among others.

### BRIEF SUMMARY

Various embodiments of the present disclosure provide techniques for the development of a personalized plan that enables a user to complete a goal. In accordance with one or more examples described herein, a goal tracking system may utilize historical data to provide a user with a plan (e.g., a personalized plan, one or more activity sequences) for achieving a goal (e.g., a health goal, etc.). The plan may divide one or more daily goals into time-bound subgoals that are determined to be achievable for the user. For example, the goal tracking system may generate one or more subgoals that were previously completed by the user. In some examples, a machine learning model (e.g., a model utilizing artificial intelligence (AI), etc.) may be utilized to generate a personalized plan for meeting a goal, as described herein. The techniques described herein may enable the development of the personalized plan for meeting a goal without human intervention or input, which may provide advantages when compared to other cognitively demanding approaches to developing personalized plans. Additionally, the techniques described herein may provide plans that are tailored to a user's abilities and thus more effective than plans developed using other techniques.

In some embodiments, a computer-implemented method includes generating, by one or more processors and using a machine learning model, a predictive activity sequence for a user that comprises a plurality of activity predictions corresponding to a plurality of activity time segments within an evaluation time period; generating, by the one or more processors and based on the predictive activity sequence, a personalized activity sequence for the user that comprises a plurality of activity subgoals corresponding to one or more activity time segments of the plurality of activity time segments within the evaluation time period; identifying, by the one or more processors, an occurrence of an activity time segment corresponding to an activity subgoal of the plurality of activity subgoals; and in response to the occurrence of the activity time segment, providing, by the one or more processors, data indicative of the activity subgoal.

In some embodiments, a computing system includes memory and one or more processors communicatively coupled to the memory, the one or more processors configured to generate, using a machine learning model, a predictive activity sequence for a user that comprises a plurality of activity predictions corresponding to a plurality of activity time segments within an evaluation time period; generate, based on the predictive activity sequence, a personalized activity sequence for the user that comprises a plurality of activity subgoals corresponding to one or more activity time segments of the plurality of activity time segments within the evaluation time period; identify an occurrence of an activity time segment corresponding to an activity subgoal of the plurality of activity subgoals; and in response to the occurrence of the activity time segment, provide data indicative of the activity subgoal.

In some embodiments, one or more non-transitory computer-readable storage media include instructions that, when executed by one or more processors, cause the one or more processors to generate, using a machine learning model, a predictive activity sequence for a user that comprises a plurality of activity predictions corresponding to a plurality of activity time segments within an evaluation time period; generate, based on the predictive activity sequence, a personalized activity sequence for the user that comprises a plurality of activity subgoals corresponding to one or more activity time segments of the plurality of activity time segments within the evaluation time period; identify an occurrence of an activity time segment corresponding to an activity subgoal of the plurality of activity subgoals; and in response to the occurrence of the activity time segment, provide data indicative of the activity subgoal.

### BRIEF DESCRIPTION OF THE DRAWINGS

FIG. 1 provides an example overview of a system that can be used to practice embodiments of the present disclosure.

FIG. 2 provides an example predictive data analysis computing entity in accordance with some embodiments discussed herein.

FIG. 3 provides an example external computing entity in accordance with some embodiments discussed herein.

FIGS. 4-5 provide examples of processes in accordance with some embodiments discussed herein.

FIG. 6 provides an example data flow in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout. Moreover, while certain embodiments of the present disclosure are described with reference to predictive data analysis, one of ordinary skill in the art will recognize that the disclosed concepts can be used to perform other types of data analysis.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example System Framework

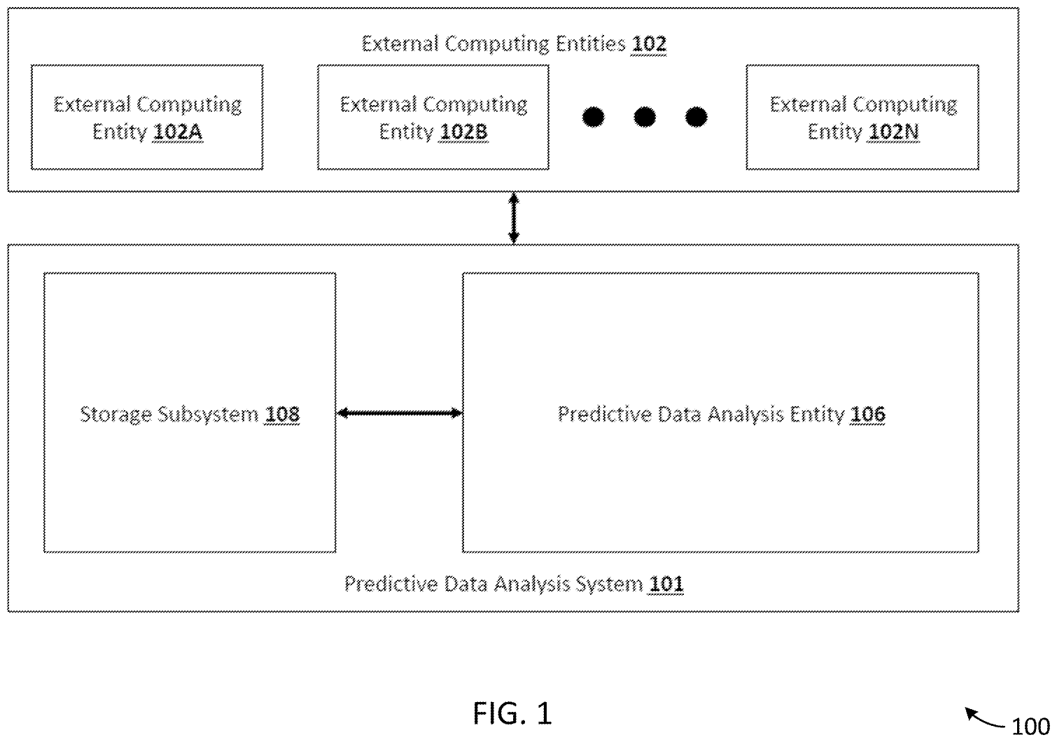

FIG. 1 provides an example overview of a system 100 that can be used to practice embodiments of the present disclosure. The system 100 includes a predictive data analysis system 101 comprising a predictive data analysis computing entity 106 configured to generate outputs that can be used to perform one or more output-based actions. The predictive data analysis system 101 may communicate with one or more external computing entities 102A-N using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (e.g., network routers, and/or the like).

The system 100 includes a storage subsystem 108 configured to store at least a portion of the data utilized by the predictive data analysis system 101. The predictive data analysis computing entity 106 may be in communication with the external computing entities 102A-N. The predictive data analysis computing entity 106 may be configured to: (i) train one or more machine learning models based on a training data store stored in the storage subsystem 108, (ii) store trained machine learning models as part of a model definition data store of the storage subsystem 108, (iii) utilize trained machine learning models to perform an action, and/or the like.

In one example, the system predictive data analysis computing entity 106 may be configured to generate a prediction, classification, and/or any other data insight based on data provided by an external computing entity such as external computing entity 102A, external computing entity 102B, and/or the like.

The storage subsystem 108 may be configured to store the model definition data store and the training data store for one or more machine learning models. The predictive data analysis computing entity 106 may be configured to receive requests and/or data from at least one of the external computing entities 102A-N, process the requests and/or data to generate outputs (e.g., predictive outputs, classification outputs, and/or the like), and provide the outputs to at least one of the external computing entities 102A-N. In some embodiments, the external computing entity 102A, for example, periodically updates/provides raw and/or processed input data to the predictive data analysis system 101. The external computing entities 102A-N may further generate user interface data (e.g., one or more data objects) corresponding to the outputs and may provide (e.g., transmit, send, and/or the like) the user interface data corresponding with the outputs for presentation to the external computing entity 102A (e.g., to an end-user).

The storage subsystem 108 may be configured to store at least a portion of the data utilized by the predictive data analysis computing entity 106 to perform one or more steps/operations and/or tasks described herein. The storage subsystem 108 may be configured to store at least a portion of operational data and/or operational configuration data including operational instructions and parameters utilized by the predictive data analysis computing entity 106 to perform the one or more steps/operations described herein. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The predictive data analysis computing entity 106 can include an analysis engine and/or a training engine. The predictive analysis engine may be configured to perform one or more data analysis techniques. The training engine may be configured to train the predictive analysis engine in accordance with the training data store stored in the storage subsystem 108.

### Example Predictive Data Analysis Computing Entity

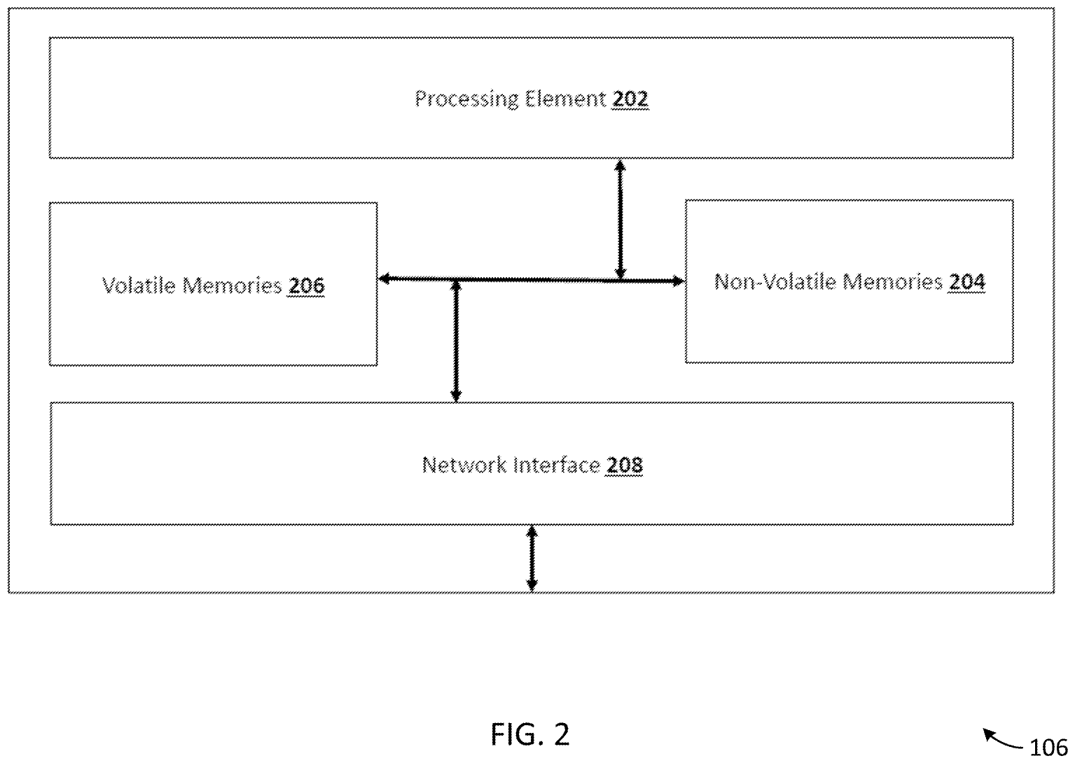

FIG. 2 provides an example predictive data analysis computing entity 106 in accordance with some embodiments discussed herein. In general, the terms computing entity, computer, entity, device, system, and/or similar words used herein interchangeably may refer to, for example, one or more computers, computing entities, desktops, mobile phones, tablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes can be performed on data, content, information, and/or similar terms used herein interchangeably.

The predictive data analysis computing entity 106 may include a network interface 208 for communicating with various computing entities, such as by communicating data, content, information, and/or similar terms used herein interchangeably that can be transmitted, received, operated on, processed, displayed, stored, and/or the like.

In one embodiment, the predictive data analysis computing entity 106 may include or be in communication with a processing element 202 (also referred to as processors, processing circuitry, and/or similar terms used herein interchangeably) that communicate with other elements within the predictive data analysis computing entity 106 via a bus, for example. As will be understood, the processing element 202 may be embodied in a number of different ways including, for example, as at least one processor/processing apparatus, one or more processors/processing apparatuses, and/or the like.

For example, the processing element 202 may be embodied as one or more complex programmable logic devices (CPLDs), microprocessors, multi-core processors, coprocessing entities, application-specific instruction-set processors (ASIPs), microcontrollers, and/or controllers. Further, the processing element 202 may be embodied as one or more other processing devices or circuitry. The term circuitry may refer to an entirely hardware embodiment or a combination of hardware and computer program products. Thus, the processing element 202 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 202 may be configured for a particular use or configured to execute instructions stored in one or more memory elements including, for example, one or more volatile memories 206 and/or non-volatile memories 204. As such, whether configured by hardware or computer program products, or by a combination thereof, the processing element 202 may be capable of performing steps or operations according to embodiments of the present disclosure when configured accordingly. The processing element 202, for example in combination with the one or more volatile memories 206 and/or or non-volatile memories 204, may be capable of implementing one or more computer-implemented methods described herein. In some implementations, the predictive data analysis computing entity 106 can include a computing apparatus, the processing element 202 can include at least one processor of the computing apparatus, and the one or more volatile memories 206 and/or non-volatile memories 204 can include at least one memory including program code. The at least one memory and the program code can be configured to, upon execution by the at least one processor, cause the computing apparatus to perform one or more steps/operations described herein.

The non-volatile memories 204 (also referred to as non-volatile storage, memory, memory storage, memory circuitry, media, and/or similar terms used herein interchangeably) may include at least one non-volatile memory device 204, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile memories 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The one or more volatile memories (also referred to as volatile storage, memory, memory storage, memory circuitry, media, and/or similar terms used herein interchangeably) can include at least one volatile memory device 206, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile memories 206 may be used to store at least portions of the databases, database instances, database management systems, data, applications, programs, program modules, scripts, source code, object code, byte code, compiled code, interpreted code, machine code, executable instructions, and/or the like being executed by, for example, the processing element 202. Thus, the databases, database instances, database management systems, data, applications, programs, program modules, scripts, source code, object code, byte code, compiled code, interpreted code, machine code, executable instructions, and/or the like may be used to control certain embodiments of the operation of the predictive data analysis computing entity 106 with the assistance of the processing element 202.

As indicated, in one embodiment, the predictive data analysis computing entity 106 may also include the network interface 208 for communicating with various computing entities, such as by communicating data, content, information, and/or the like that can be transmitted, received, operated on, processed, displayed, stored, and/or the like. Such communication data may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

### Example External Computing Entity

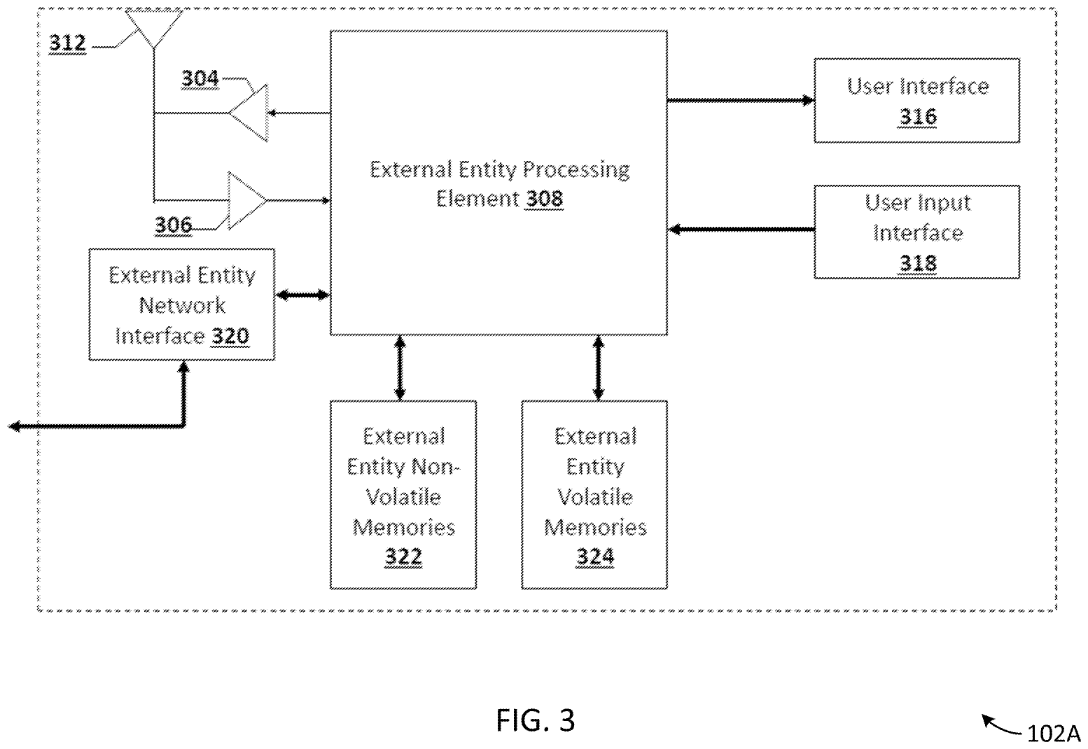

FIG. 3 provides an example external computing entity 102A in accordance with some embodiments discussed herein. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. The external computing entities 102A-N can be operated by various parties. As shown in FIG. 3, the external computing entity 102A can include an antenna 312, a transmitter 304 (e.g., radio), a receiver 306 (e.g., radio), and/or an external entity processing element 308 (e.g., CPLDs, microprocessors, multi-core processors, coprocessing entities, ASIPs, microcontrollers, and/or controllers) that provides signals to and receives signals from the transmitter 304 and the receiver 306, correspondingly. As will be understood, the external entity processing element 308 may be embodied in a number of different ways including, for example, as at least one processor/processing apparatus, one or more processors/processing apparatuses, and/or the like as described herein with reference to the processing element 202.

The signals provided to and received from the transmitter 304 and the receiver 306, correspondingly, may include signaling information/data in accordance with air interface standards of applicable wireless systems. In this regard, the external computing entity 102A may be capable of operating with one or more air interface standards, communication protocols, modulation types, and access types. More particularly, the external computing entity 102A may operate in accordance with any of a number of wireless communication standards and protocols, such as those described above with regard to the predictive data analysis computing entity 106. In a particular embodiment, the external computing entity 102A may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102A may operate in accordance with multiple wired communication standards and protocols, such as those described above with regard to the predictive data analysis computing entity 106 via an external entity network interface 320.

Via these communication standards and protocols, the external computing entity 102A can communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102A can also download changes, add-ons, and updates, for instance, to its firmware, software (e.g., including executable instructions, applications, program modules), operating system, and/or the like.

According to one embodiment, the external computing entity 102A may include location determining embodiments, devices, modules, functionalities, and/or the like. For example, the external computing entity 102A may include outdoor positioning embodiments, such as a location module adapted to acquire, for example, latitude, longitude, altitude, geocode, course, direction, heading, speed, universal time (UTC), date, and/or various other information/data. In one embodiment, the location module can acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating a position of the external computing entity 102A in connection with a variety of other systems, including cellular towers, Wi-Fi access points, and/or the like. Similarly, the external computing entity 102A may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments can be used in a variety of settings to determine the location of someone or something to within inches or centimeters.

The external computing entity 102A may include a user interface 316 (e.g., a display, speaker, and/or the like) that can be coupled to the external entity processing element 308. In addition, or alternatively, the external computing entity 102A can include a user input interface 319 (e.g., keypad, touch screen, microphone, and/or the like) coupled to the external entity processing element 308).

For example, the user interface 316 may be a user application, browser, and/or similar words used herein interchangeably executing on and/or accessible via the external computing entity 102A to interact with and/or cause the display, announcement, and/or the like of information/data to a user. The user input interface 318 can comprise any of a number of input devices or interfaces allowing the external computing entity 102A to receive data including, as examples, a keypad (hard or soft), a touch display, voice/speech interfaces, motion interfaces, and/or any other input device. In embodiments including a keypad, the keypad can include (or cause display of) the conventional numeric (0-9) and related keys (#, *, and/or the like), and other keys used for operating the external computing entity 102A and may include a full set of alphabetic keys or set of keys that may be activated to provide a full set of alphanumeric keys. In addition to providing input, the user input interface 318 can be used, for example, to activate or deactivate certain functions, such as screen savers, sleep modes, and/or the like.

The external computing entity 102A can also include one or more external entity non-volatile memories 322 and/or one or more external entity volatile memories 324, which can be embedded within and/or may be removable from the external computing entity 102A. As will be understood, the external entity non-volatile memories 322 and/or the external entity volatile memories 324 may be embodied in a number of different ways including, for example, as described herein with reference to the non-volatile memories 204 and/or the external volatile memories 206.

### III. Examples of Certain Terms

In some embodiments, the term “machine learning model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning model may include one or more machine learning models configured, trained (e.g., jointly, separately, etc.), and/or the like to generate one or more predictive outputs, such as predictive activity sequences, for one or more users within a population of users. A machine learning model may include one or more of any type of machine learning model including one or more supervised, unsupervised, semi-supervised, reinforcement learning models, and/or the like. In some examples, a machine learning model may include multiple models configured to perform one or more different stages of a prediction process.

In some embodiments, a machine learning model includes a natural language processing (NLP) model. A machine learning model, for example, may include an encoder-decoder network. The encoder-decoder network may include one or more encoder models and/or one or more decoder models. In some examples, the one or more encoder and/or decoder models, for example, may include one or more neural networks, such as recurrent neural networks, convolutional neural networks, and/or the like. In some examples, one or more encoder models may be trained to generate one or more latent activity representations (e.g., lower-dimensional embeddings, etc.) for a user that represents general activity patterns for the user. The one or more decoder models may be trained to generate a predictive activity sequence for a user during an evaluation time period based on the one or more latent activity representations.

In some embodiments, a machine learning model is trained, using one or more supervisory training techniques, using a training dataset. The training dataset, for example, may include a plurality of historical activity durations for a plurality of users within a population of users. In some examples, a machine learning model may be initially trained on the training dataset and then fine-tuned on a portion of the training dataset, for example, to personalize the machine learning model for a particular user associated with a subset of the historical activity durations.

In some embodiments, the term “activity sequence” refers to one or more data elements associated with a time period. Each data element, for example, may represent an activity duration during the time period. For instance, a data element may include one or more values (and/or a range of values) that represent an amount of time and a corresponding activity. A data element, for example, may correspond to a type of activity, such as walking, jogging, running, cycling, reading, meditation, breathing exercises, and/or the like and a duration of time during which a user engages in the type of activity.

In some examples, each data element of an activity sequence may correspond to a time segment within a time period, such as an evaluation time period as described herein. The time period may include any unit of measurement for measuring a duration of time. In some examples, the time period may be configurable for a user and/or a predictive output for a user. By way of example, a time period may include one or more minutes, hours, days, weeks, months, years, and/or the like. In some examples, an activity sequence may include one or more data elements for each of one or more time segments within the time period. By way of example, in the event that the time period is a single day, the single day may be divided into a first time segment between 12:01 a.m. to 6:00 a.m., a second time segment between 6:00 a.m. to 12:01 p.m., a third time segment between 12:01 p.m. to 6:00 p.m., a fourth time segment between 6:00 p.m. to 12:01 a.m., and/or the like. In such a case, an activity sequence may include one or more data elements that indicate an amount of time that a user performs a particular activity during the first, second, third, and fourth time segments.

In some embodiments, the term “predictive activity sequence” refers to a predicted activity sequence for an evaluation time period. The data elements of a predictive activity sequence may include a plurality of activity predictions. Each activity prediction may represent a static and/or probabilistic amount (and/or range) of time that a user is expected to spend performing or otherwise engaging in an activity.

In some embodiments, a predictive activity sequence is an output of a machine learning model. In some examples, the machine learning model may be tailored to a user to generate a predictive activity sequence that is learned from historical activity patterns of the user. As an illustrative example, a predictive activity sequence for moderate physical activity (MPA) may include five activity predictions respectively corresponding to five time segments within an evaluation time period of a day. Each activity prediction may include a range of values. For example, a first activity prediction may include a first value (e.g., 10 minutes) and a second value (e.g., 15 minutes) indicating that a user is likely to perform 10 to 15 minutes of MPA during a time segment corresponding to the first activity prediction. A predictive activity sequence may include an individual activity prediction for each of the time segments within the evaluation time period.

In some embodiments, the term “personalized activity sequence” refers to a recommended activity sequence for a user during an evaluation time period. The data elements of a personalized activity sequence may include a plurality of activity subgoals. Each activity subgoal may represent a defined amount (and/or range) of time that a user may spend performing and/or otherwise engaging in an activity to achieve an activity threshold (e.g., a health goal, etc.) for an evaluation time period. For example, the personalized activity sequence may include a set of recommended behaviors (e.g., activity durations, subgoals, etc.) for achieving an activity threshold.

In some embodiments, a personalized activity sequence is based on a predictive activity sequence for a user. For example, an activity subgoal of a personalized activity sequence may include a value that is selected from one or more activity predictions from one or more predictive activity sequences generated for a user. For instance, if a predictive activity sequence has a first element indicating that a user is likely to perform 10 to 15 minutes of MPA, a corresponding personalized activity sequence for the user may have a first element that indicates 10 minutes of MPA, 11 minutes of MPA, or any other duration of MPA included in the predicted range. In some other cases, a personalized activity sequence may include elements selected from outside of a range of values indicated by a respective element of a predictive activity sequence, as described in further detail herein. In some examples, each element of a personalized activity sequence may be referred to as a subgoal.

In some embodiments, the term “activity notification” refers to information notifying a user to complete the subgoal. Completing the subgoal may include performing an activity for a duration indicated by an activity subgoal of a personalized activity sequence. The activity notification may be included in a message that is provided to a user device, such as a wearable device (e.g., a smartwatch), a handheld device (e.g., smartphone, etc.), and/or the like. In some examples, a user may also be provided with a goal notification to achieve an activity threshold (e.g., an overarching activity goal). A goal notification may be provided with the activity notification and/or independently of the activity notification. Additionally, or alternatively, a user may be provided with a status notification indicating a status of an activity subgoal, an activity threshold, and/or the like.

In some embodiments, the term “evaluation time period” refers to a duration (e.g., an amount of time) corresponding to a predictive activity sequence and/or a personalized activity sequence. For example, an evaluation time period may include one or more activity time segments. A predictive activity sequence and/or a personalized activity sequence may include one or more data elements (e.g., an activity prediction, an activity subgoal, etc.) that correspond to each activity time segment of the evaluation time period. By way of example, an evaluation time period may be a single day with five activity time segments.

In some embodiments, the term “activity time segment” refers to a time segment (e.g., a duration, a time period, etc.) within an evaluation time period. An evaluation time period may include a plurality of activity time segments. By way of example, an evaluation time period may include a day (e.g., a 24-hour time period) that may be divided into a plurality of daily time segments, such as a first activity time segment between 6:00 a.m. to 9:00 a.m., a second activity time segment between 9:00 a.m. to 12:00 p.m., a third activity time segment between 12:00 p.m. to 3:00 p.m., a fourth activity time segment between 3:00 p.m. to 6:00 p.m., and/or the like. In some examples, an evaluation time period may include activity time segments that span the entire evaluation time period. In addition, or alternatively, an evaluation time period may include activity time segments that span a portion of the evaluation time period. In some examples, each activity time segment in an evaluation time period may include an equal time duration (e.g., three hours, etc.). In addition, or alternatively, two or more activity time segments may include different time durations.

In some embodiments, the term “activity subgoal” refers to a duration of an activity that is recommended for a user. A duration of an activity may correspond to a particular activity time segment within an evaluation time period. Completing one or more activity subgoals within an evaluation time period may result in the completion (and/or near completion) of an activity threshold. An activity subgoal may be selected from one or more activity predictions included in one or more predictive activity sequences for an evaluation time period. By way of example, an activity subgoal is 5 minutes of MPA (e.g., between 6:00 a.m. and 9:00 a.m.).

In some embodiments, the term “activity threshold” refers to an amount of activity during an evaluation time period. For example, an activity threshold may describe a personal activity goal, such as a health goal, a productivity goal, a fitness goal, and/or the like, of a user during an evaluation time period. The activity threshold may be represented as a duration of time, a particular activity, and/or one or more expected results from performing a particular activity for a duration of time (e.g., calories burned, etc.). As an example, an activity threshold may include a daily activity goal for a user, such as 30 minutes of daily activity (e.g., walking, running, etc.) within an evaluation time period of 24 hours. By way of example, an activity threshold may include completing thirty minutes of walking per day, completing three hours of running per week, performing forty hours of work per week, and/or the like.

In some embodiments, an activity threshold is generated by a machine learning model. In addition, or alternatively, an activity threshold may be selected by a user. In some examples, an activity threshold may be initially selected by a user and the machine learning model may adjust the activity threshold, such that a likelihood of completion is higher for the adjusted activity threshold when compared to the activity threshold initially selected by the user. In some examples, completing one or more subgoals during an evaluation period may result in completion of the activity threshold.

In some embodiments, the term “reward value” refers to a value or a quantity that indicates a difference between an activity subgoal and a corresponding activity prediction (e.g., an upper bound of an activity prediction, a lower bound of an activity prediction, etc.). For example, if an activity subgoal is greater than a corresponding activity prediction for a respective time segment (e.g., an activity subgoal of 15 minutes of MPA and an activity prediction of 5 to 10 minutes of MPA), a corresponding reward value may be positive (e.g., a reward value of 5). If an activity subgoal is less than a corresponding activity prediction for a respective time segment (e.g., an activity subgoal of 3 minutes of MPA and an activity prediction of 5 to 10 minutes of MPA), a corresponding reward value may be negative (e.g., a reward value of negative 2). In some examples, the difference between the activity subgoal and the corresponding activity prediction may be referred to as a degree or extent to which the activity subgoal is greater than or less than the respective activity prediction.

In some embodiments, the term “activity probability” refers to a value indicating a likelihood that a user will complete an activity subgoal. An activity probability may be expressed as a relative value, such as a percentage, ratio, proportion, and/or the like. In some examples, an activity probability may correspond each of one or more activity subgoals for a user. By way of example, an activity probability for an activity subgoal of 5 minutes of MPA during a first time segment of an evaluation time period may be 95% indicating that a user may have a 95% likelihood of completing 5 minutes of MPA during a first time segment.

In some embodiments, the term “completing a goal” refers to a quantity or duration of an activity satisfying a threshold quantity or duration of the activity. In some examples, the terms “completing a goal,” “satisfying a goal,” “accomplishing a goal,” and “satisfying a threshold,” may be used interchangeably. In some examples, a user may complete a goal by completing each subgoal corresponding to the goal. In some examples, a user may receive a notification that a goal or a subgoal has been completed.

In some embodiments, the term “plan” refers to a set of activities corresponding to respective time segments. In some examples, an activity sequence (e.g., a personalized activity sequence) may be an example of a plan. A user may complete a goal or one or more subgoals by following or otherwise completing a plan. Additionally, or alternatively, the terms “plan” and “health plan,” and “personalized plan” may be used interchangeably herein.

In some embodiments, the term “contextual factors” refers to one or more factors or parameters that influence an ability of a user to complete an activity subgoal, activity threshold, and/or the like. For example, contextual factors may include weather and/or climate factors, temporal factors, location factors, and/or the like that may impact a user's ability and/or likelihood to complete an activity subgoal, activity threshold, and/or the like.

In some embodiments, the term “sampling” refers to the process of selecting a subset of data points or examples from a larger dataset for the purpose of analysis, model training, or other computational tasks. Sampling may be utilized by a machine learning model for various tasks, including managing large datasets, improving computational efficiency, and addressing issues related to data imbalance. In some examples, the terms “sampling,” “generating,” and “selecting” may be used interchangeably herein.

### IV. Overview

Various goal tracking systems may be utilized to bring about behavior change. Various health applications may utilize such goal tracking systems to assist in the completion of one or more health goals for an individual. As an illustrative example of a goal tracking system, a smartwatch or any other type of device may run an activity ring application that tracks progress for one or more daily goals, such as a goal of performing a specific duration of MPA or a goal for performing a duration of standing hours, among other examples. Some other goal tracking systems may include weight tracking and diet tracking systems. Despite the popularity of such goal tracking systems, the fundamental approach of some goal tracking has not changed for decades. For example, some fitness applications set goals and track goal progress, but do not provide a plan for achieving respective goals.

Goal tracking without a plan may prevent an individual from completing a goal. In some examples, individuals may be inclined to choose immediate rewards over rewards that come later in the future. Such a tendency may cause an individual to perform various activities or complete various tasks relatively early within a day, which may contribute to fatigue or exhaustion that prevents the individual from completing tasks later in the day that contribute to the completion of the goal. A plan that distributes appropriate tasks throughout a day, including intermediate tasks for meeting short-term, intermediate goals, may be expected to increase the likelihood of completion for a daily goal. Developing or appropriately updating such a plan to accommodate various life events may be burdensome for an individual. For example, an individual may not be capable of mentally tracking and planning various tasks and goals on a daily basis or throughout the day. Additionally, some plans for achieving goals may not be personalized to match abilities and past behaviors of an individual, which may reduce the likelihood of goals being completed.

In accordance with one or more examples as described herein, a goal tracking system may utilize historical data to provide a user with a plan (e.g., a personalized plan, one or more activity sequences, etc.) for meeting a goal. The plan may divide one or more daily goals into time-bound subgoals that are determined to be achievable for the user. For example, the goal tracking system may generate one or more subgoals that were previously completed by the user. Additionally, or alternatively, the goal tracking system may generate one or more subgoals that are within a threshold range of one or more subgoals that were previously completed by the user. For example, if a user has previously performed 60 minutes of MPA between 6 a.m. and 9 a.m., the goal tracking system may provide the user with a subgoal of 70 minutes of MPA between 6 a.m. and 9 a.m. (e.g., a previously completed subgoal plus an additional ten minutes). In some examples, a machine learning model (e.g., a model utilizing artificial intelligence (AI)) may be utilized to generate a personalized plan for meeting a goal, as described herein.

The techniques described herein may be performed using a plurality of steps (e.g., operations), which are described in further detail herein. Some illustrative examples of the described techniques may be described with reference to weight loss objectives or activity goals for one or more days. Although some examples refer to goals corresponding to a given day, the techniques described herein may be applied to goals corresponding to any time period (e.g., any duration), such as a day, a week, a month, or a year, among other examples. The techniques described herein may be implemented by various devices (e.g., various electronic devices), such as phones, wearable devices, or any other type of computing device known in the art. The techniques described herein may enable the development of a personalized plan for meeting a goal without human intervention or input, which may provide advantages when compared to other cognitively demanding approaches to developing personalized plans.

Examples of technologically advantageous embodiments of the present disclosure include: (i) tailoring activity recommendations to an individual based on historical data for the individual, (ii) providing notifications using notification timing that increases the likelihood of a goal or subgoal being completed, and (iii) automatic segmentation of longer-term goals into shorter-term, more readily achievable and personalized subgoals, among others. Other technical improvements and advantages may be realized by one of ordinary skill in the art.

### V. Example System Operations

As indicated, various embodiments of the present disclosure make important technical contributions to activity tracking technologies. In particular, systems and methods are disclosed herein for generating and intelligently surfacing personalized and achievable activity subgoals to a user at particular times throughout an evaluation time period to improve the user's likelihood of achieving an activity threshold. For example, as described herein, some techniques of the present disclosure enable the transmission of real-time activity notifications that incrementally instruct a user to complete subgoals at times that are tailored to the particular activity trends of the user. In this manner, some techniques of the present disclosure may improve upon traditional activity tracking techniques by providing improved timing mechanisms and personalized subgoal that adhere to dynamic changes of a user's schedule to increase the effectiveness of activity recommendations for the user.

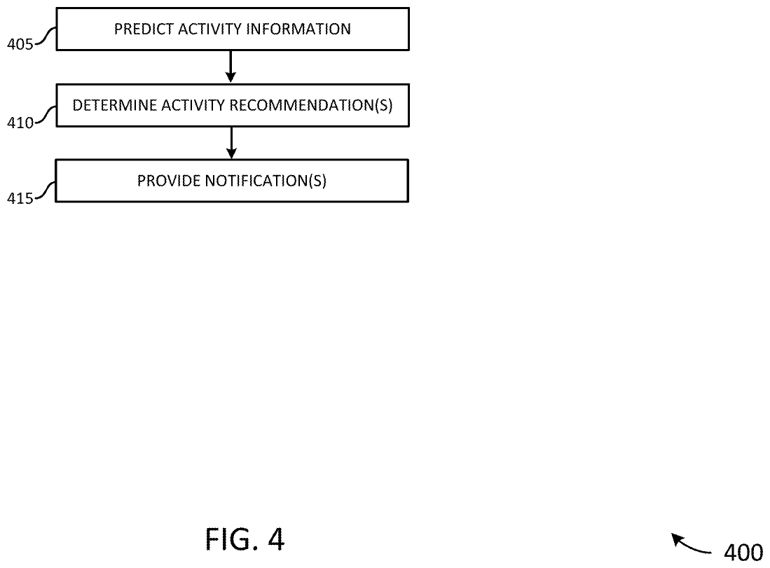

FIG. 4 illustrates an example process 400 for explanatory purposes. Although the example process 400 depicts a particular sequence of steps/operations, the sequence may be altered without departing from the scope of the present disclosure. For example, some of the steps/operations depicted may be performed in parallel or in a different sequence that does not materially impact the function of the process 400. In other examples, different components of an example device or system that implements the process 400 may perform functions at substantially the same time or in a specific sequence.

In some embodiments, the process 400 includes, at step/operation 405, predicting activity information. For example, a system may generate one or more predictive activity sequences for a user. In some examples, the one or more predictive activity sequences may be generated at a beginning (and/or a threshold time period preceding the beginning, etc.) of an evaluation time period. For example, at a first time during an evaluation time period, such as a day (e.g., at 12:01 a.m., etc.), a system may generate the one or more predicted activity sequences.

In some embodiments, an activity sequence includes one or more data elements associated with a time period. Each data element, for example, may represent an activity duration during the time period. For instance, a data element may include one or more values (and/or a range of values) that represent an amount of time and a corresponding activity. A data element, for example, may correspond to a type of activity, such as walking, jogging, running, cycling, reading, meditation, breathing exercises, and/or the like and a duration of time during which a user engages in the type of activity.

In some examples, each data element of an activity sequence may correspond to a time segment within a time period, such as an evaluation time period as described herein. The time period may include any unit of measurement for measuring a duration of time. In some examples, the time period may be configurable for a user and/or a predictive output for a user. By way of example, a time period may include one or more minutes, hours, days, weeks, months, years, and/or the like. In some examples, an activity sequence may include one or more data elements for each of one or more time segments within the time period. By way of example, in the event that the time period is a single day, the single day may be divided into a first time segment between 12:01 a.m. to 6:00 a.m., a second time segment between 6:00 a.m. to 12:01 p.m., a third time segment between 12:01 p.m. to 6:00 p.m., a fourth time segment between 6:00 p.m. to 12:01 a.m., and/or the like. In such a case, an activity sequence may include one or more data elements that indicate an amount of time that a user performs a particular activity during the first, second, third, and/or fourth time segments.

In some embodiments, a predictive activity sequence is a predicted activity sequence for an evaluation time period. The data elements of the predictive activity sequence may include a plurality of activity predictions. Each activity prediction may represent a static and/or probabilistic amount (and/or range) of time that a user is expected to spend performing or otherwise engaging in an activity.

In some embodiments, a predictive activity sequence is an output of a machine learning model. In some examples, the machine learning model may be tailored to a user to generate a predictive activity sequence that is learned from historical activity patterns of the user. As an illustrative example, a predictive activity sequence for moderate physical activity (MPA) may include five activity predictions respectively corresponding to five time segments within an evaluation time period of a day. Each activity prediction may include a range of values. For example, a first activity prediction may include a first value (e.g., 10 minutes) and a second value (e.g., 15 minutes) indicating that a user is likely to perform 10 to 15 minutes of MPA during a time segment corresponding to the first activity prediction. A predictive activity sequence may include an individual activity prediction for each of the time segments within the evaluation time period.

In some embodiments, a system generates the one or more predictive activity sequences using a machine learning model. For example, a machine learning model may be leveraged to generate the one or more predictive activity sequences based on historical activity information for a population of users (e.g., a set of multiple users including a specific user).

In some embodiments, the machine learning model is a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning model may include one or more machine learning models configured, trained (e.g., jointly, separately, etc.), and/or the like to generate one or more predictive outputs, such as predictive activity sequences, for one or more users within a population of users. A machine learning model may include one or more of any type of machine learning model including one or more supervised, unsupervised, semi-supervised, reinforcement learning models, and/or the like. In some examples, a machine learning model may include multiple models configured to perform one or more different stages of a prediction process.

In some embodiments, a machine learning model includes a natural language processing (NLP) model. A machine learning model, for example, may include an encoder-decoder network. The encoder-decoder network may include one or more encoder models and/or one or more decoder models. In some examples, the one or more encoder and/or decoder models, for example, may include one or more neural networks, such as recurrent neural networks, convolutional neural networks, and/or the like. In some examples, one or more encoder models may be trained to generate one or more latent activity representations (e.g., lower-dimensional embeddings, etc.) for a user that represents general activity patterns for the user. The one or more decoder models may be trained to generate a predictive activity sequence for a user during an evaluation time period based on the one or more latent activity representations.

In some embodiments, a machine learning model is trained, using one or more supervisory training techniques, using a training dataset. The training dataset, for example, may include a plurality of historical activity durations for a plurality of users within a population of users. In some examples, a machine learning model may be initially trained on the training dataset and then fine-tuned on a portion of the training dataset, for example, to personalize the machine learning model for a particular user associated with a subset of the historical activity durations.

In some embodiments, a system, using the machine learning model, generates one or more predicted activity sequences for a user and/or an evaluation time period (e.g., one or more hours, days, weeks, months, years, etc.).

In some embodiments, the evaluation time period is a duration (e.g., an amount of time) corresponding to a predictive activity sequence and/or a personalized activity sequence (as described herein). For example, the evaluation time period may include one or more activity time segments. A predictive activity sequence and/or a personalized activity sequence may include one or more data elements (e.g., an activity prediction, an activity subgoal, etc.) that correspond to each activity time segment of the evaluation time period. By way of example, an evaluation time period may be a single day with five activity time segments.

In some embodiments, the activity time segment is a time segment (e.g., a duration, a time period, etc.) within the evaluation time period. The evaluation time period may include a plurality of activity time segments. By way of example, the evaluation time period may include a day (e.g., a 24-hour time period) that may be divided into a plurality of daily time segments, such as a first activity time segment between 6:00 a.m. to 9:00 a.m., a second activity time segment between 9:00 a.m. to 12:00 p.m., a third activity time segment between 12:00 p.m. to 3:00 p.m., a fourth activity time segment between 3:00 p.m. to 6:00 p.m., and/or the like. In some examples, the evaluation time period may include activity time segments that span the entire evaluation time period. In addition, or alternatively, an evaluation time period may include activity time segments that span a portion of the evaluation time period. In some examples, each activity time segment in an evaluation time period may include an equal time duration (e.g., three hours, etc.). In addition, or alternatively, two or more activity time segments may include different time durations.

In some examples, an activity time segment may be defined by one or more start and/or end times. A start and/or end time of an activity time segment may be configurable and/or application specific. In some examples, a system may select a first activity time segment length for a first activity type (e.g., running) and/or a second activity time segment length for a second activity type (e.g., cycling). The second time segment length may be longer than the first time segment length. In addition, or alternatively, a first activity sequence may include one-hour time segments (e.g., 6 a.m. to 7 a.m., 7 a.m. to 8 a.m., 8 a.m. to 9 a.m., and so forth) and a second activity sequence may include three-hour time segments (e.g., 6 a.m. to 9 a.m., 9 a.m. to 12 p.m., 12 p.m. to 3 p.m., and so forth).

In some embodiments, the process 400 includes, at step/operation 410, determining one or more activity recommendations. For example, a system may generate one or more personalized activity sequences for a user. For instance, the system may leverage the predicted activity information to generate, select, and/or the like one or more personalized activity sequences. The one or more personalized activity sequences may enable a user to complete an activity threshold during an evaluation time period. For example, a user may be associated with an activity threshold. The personalized activity sequence may be tailored to the activity threshold.

In some embodiments, the activity threshold is an amount of activity during an evaluation time period. For example, the activity threshold may describe a personal activity goal, such as a health goal, a productivity goal, a fitness goal, and/or the like, of a user during the evaluation time period. The activity threshold may be represented as a duration of time, a particular activity, and/or one or more expected results from performing a particular activity for a duration of time (e.g., calories burned, etc.). As an example, the activity threshold may include a daily activity goal for a user, such as 30 minutes of daily activity (e.g., walking, running, etc.) within an evaluation time period of 24 hours. By way of example, the activity threshold may include completing thirty minutes of walking per day, completing three hours of running per week, performing forty hours of work per week, and/or the like.

In some embodiments, the personalized activity sequence is a recommended activity sequence for a user during an evaluation time period. The data elements of a personalized activity sequence may include a plurality of activity subgoals. Each activity subgoal may represent a defined amount (and/or range) of time that a user may spend performing and/or otherwise engaging in an activity to achieve an activity threshold (e.g., a health goal, etc.) for an evaluation time period. For example, the personalized activity sequence may include a set of recommended behaviors (e.g., activity durations, subgoals, etc.) for achieving an activity threshold.

In some embodiments, a personalized activity sequence is based on a predictive activity sequence for a user. For example, an activity subgoal of a personalized activity sequence may include a value that is selected from one or more activity predictions from one or more predictive activity sequences generated for a user. For instance, if a predictive activity sequence has a first element indicating that a user is likely to perform 10 to 15 minutes of MPA, a corresponding personalized activity sequence for the user may have a first element that indicates 10 minutes of MPA, 11 minutes of MPA, or any other duration of MPA included in the predicted range. In some other cases, a personalized activity sequence may include elements selected from outside of a range of values indicated by a respective element of a predictive activity sequence, as described in further detail herein. In some examples, each element of a personalized activity sequence may be referred to as a subgoal.

By way of example, the activity threshold may include a daily goal, which may include a quantity and/or duration of activity to perform throughout a day. In the event that the daily goal is 30 minutes of MPA per day, the system may predict an amount of MPA that one or more users typically engage in for each of the time segments in the day. The predicted amount of MPA may be probabilistic, and may include a time range (e.g., 30 to 45 minutes) that actual MPA performed by a user is likely to be within. The system may predict a time range of MPA for each time segment within an evaluation time period (e.g., within a day). For example, the system may predict a first time range (e.g., 5 to 10 minutes of MPA) for a first time segment (e.g., 6 a.m. to 9 a.m.), a second time range (e.g., 30 to 40 minutes of MPA) for a second time segment (e.g., 9 a.m. to 12 p.m.), a third time range (e.g., 0 to 10 minutes of MPA) for a third time segment (e.g., 12 p.m. to 3 p.m.), a fourth time range (e.g., 0 to 10 minutes of MPA) for a fourth time segment (e.g., 3 p.m. to 6 p.m.), and a fifth time range (e.g., 5 to 20 minutes of MPA) for a fifth time segment (e.g., 6 p.m. to 9 p.m.). The system may refrain from predicting activity durations for time periods when one or more users are expected to be sleeping or sedentary (e.g., 9 p.m. to 6 a.m.). In some other cases, the system may predict that a probable activity time during such periods is zero or a near-zero time range (e.g., a time range where at least one value in the range is zero, such as 0 to 5 minutes).

In some examples, the system may sample a personalized activity sequence that has a highest likelihood of satisfying an activity threshold from one or more predictive activity sequences for a user. The system, for example, may sample the personalized activity sequence based on activity predictions from the sampled activity sequences summing to a value that satisfies an activity threshold and/or summing to a value that is within a threshold range of the activity threshold. In some examples, sampling the personalized activity sequence may be based on whether the activity subgoals of the personalized activity sequence sum to a value that satisfies the activity threshold and/or whether the user has previously completed the same and/or similar activity sequence. In some examples, the sampling selects a personalized activity sequence from the user's own personalized machine learning model. In this manner, the personalized activity sequence may include activity subgoals that have been previously performed by the user. In such cases, the user may be capable of repeating the personalized activity sequence because they have performed the personalized activity sequence in the past.

In some embodiment, a machine learning model used to perform the activity sequence predictions may be personalized to a user or may otherwise be capable of outputting and/or generating some information that is personalized to the user. In some examples, the machine learning model may be initially trained on a training dataset that includes data for a population of user and then fine-tuned for a single user. In some examples, the machine learning model may be probabilistic. Due to variation in human behavior (e.g., one or more users may be unlikely to exercise for a same duration each day or at a same time each day), the machine learning model may generate predictive activity sequences that include uncertainty estimations and/or otherwise provide ranges of information that account for uncertainty. For example, the machine learning model may generate a range of durations for an activity (e.g., 20 to 30 minutes of MPA) for each time segment in the activity sequence.

In some examples, the machine learning model may include an encoder-decoder network. The encoder-decoder network may receive daily activity sequences of a plurality of users within a population and may generate latent activity patterns (e.g., lower-dimensional embedding, etc.) that represent general level daily activity patterns for the users. In some examples, a latent activity pattern may include one or more predictions indicating that one or more activities occur during mornings of some days, evenings of other days, and/or the like. In some examples, a latent activity pattern may include one or more predictions indicating that activity (e.g., a same or similar amount of activity) occurs both in the morning and in the afternoon (e.g., for a given one or more days). A generative sequence for sequencing of a neural network may learn one or more latent activity patterns. In some examples, noise may be added to one or more latent activity patterns to generate multiple daily activity sequences (e.g., multiple predicted activity sequences) using a decoding step.

The machine learning model may be fine-tuned (e.g., trained, etc.) for a user (e.g., for a specific user) based on data (e.g., activity information, historical activity sequences) for the user. Additionally, or alternatively, one or more attributes for the user (e.g., age of the user, gender of the user, comorbidities of the user), one or more contextual factors (e.g., weather, time of day, day of the week), or any combination thereof may be used to train (e.g., fine-tune) the machine learning model. For example, an age of the user and climate information for a location of the user may be used as inputs (e.g., training inputs) for the machine learning model. In some examples, the machine learning model may be trained using timing information associated with the user or behaviors of the user. For example, historical information indicating days or times that various activities are performed by a user may be used to train the machine learning model. Additionally, or alternatively, the machine learning model may be trained using information that indicates a current time or a current day.

The system may select one or more predictive activity sequences from the latent activity patterns that are applicable for a particular user and/or evaluation time period. For example, the system may select a latent activity pattern that corresponds to a day of a week or month that the user is expected to repeat an activity sequence similar to the latent activity pattern. One or more of the operations described herein may be performed using techniques for fine-tuning natural language processing (NLP) foundational models.

In some examples, a user may have an activity threshold (e.g., an MPA goal) of 30 minutes per day. Each day or a portion of each day (e.g., 6 a.m. to 12 p.m.) may be divided into one-hour segments. A length of each segment may be application specific. For example, one-hour time segments may be utilized for an MPA goal and two-hour time segments may be utilized for a running goal. Using 1-hour time segments for a portion of a day extending from 6 a.m. to 12 p.m. may result in 18 total time segments for the day. A multi-dimensional vector may be utilized to indicate how much moderate activity is performed for each time segment. For example, an ith dimension of an 18-dimensional vector may indicate or otherwise represent a quantity of MPA (e.g., between hour (6 AM+i) to hour (6 AM+i+1)). On a given day, d, for each user, an 18-dimensional vector may be generated (e.g., predicted) based on past data and user specific information (e.g., age, gender, pre-existing conditions). Each 18-dimensional vector may be generated using an AI model (e.g., a machine learning model) with fine-tuning to enable sampling. The result of the sampling may be a set of 18-dimensional vectors that represent the amount of activity respective users are expected to perform at respective hours within a day.

In some examples, no predictive activity sequence may accomplish an activity threshold for a user. In such cases, the system may select (e.g., sample) a personalized activity sequence that is closest to achieving the activity threshold when compared to other predictive activity sequences generated by the machine learning model. The machine learning model may then update a predictive activity sequence to achieve the activity threshold. For example, the machine learning model may make one or more changes to one or more activity predictions of the predictive activity sequence to satisfy the activity threshold. In some examples, the machine learning model may refrain from updating the predictive activity sequence.

In some examples, each element of a personalized activity sequence may represent or otherwise be described as an activity subgoal. Completing each activity subgoal of a personalized activity sequence may result in the completion of an activity threshold (e.g., an overarching goal, a daily goal, a weekly goal, etc.). In some examples, the system may suggest or otherwise inform a user that one or more activity subgoals are to be completed. In such cases, providing the user with one or more activity notifications to complete one or more subgoals may facilitate the completion of an activity threshold. In some examples, a personalized activity sequence may include an activity subgoal for each time segment of an evaluation time period.

In some examples, generating a personalized activity sequence for a user may involve optimizing one or more sequential decision-making and/or dynamic control problems that involve temporal credit assignment. Such sequential decision-making and/or dynamic control problems may include determining a series of activities (e.g., behaviors, actions, etc.) that accomplish an end result. Additionally, or alternatively, one or more determinations may be made as to whether a subgoal at a specific time (e.g., a time segment) has caused an activity threshold completion. In some examples, one or more approximation algorithms, such as a finite-horizon dynamic control model, may be utilized to optimize the dynamic control problem. In some examples, one or more subgoal recommendations may be mapped to and/or optimized for using a temporal credit assignment problem. In such cases, a subgoal recommendation may include a quantity of temporal steps (e.g., a day may be divided into a quantity of time segments).

The finite-horizon optimal control problem may be described using the following notation. The variable g may be an activity threshold for an evaluation time period, such as a day. The evaluation time period may be divided into k activity segments. An activity prediction may be generated indicating how much of an activity (e.g., an activity corresponding to an activity threshold) a user may perform for each of the k time segments. An example predictive activity sequence may be represented by X, where X=[x₁, x₂, x₃, . . . , xₖ]. A state variable may be generated, sₜ, such that sₜ=Σᵢ₌₁^{t}xᵢ. The state variable, sₜ, may represent an amount of activity a user has performed until a time, t (e.g., during a time period that extends from a first time to a second time). A quantity g−sₜ may represent an activity threshold remaining after time t (e.g., a portion of activity associated with a goal that has not yet been performed by a user). If g−sₜ is zero or negative, then the activity threshold has been completed by the user. At each step (e.g., for each element of an activity sequence), an adjustment, uₜ, may be made, such that g=Σᵢ₌₁^{K}xᵢ+uᵢ. A subgoal for an activity segment, t, may be xₜ+uₜ. At the beginning of the evaluation time period, a state variable may have a first value, s₁. At a second time within the evaluation time period, and based on uₜ, the state variable may have a second value, sₜ₊₁.

A transition probability, p(sₜ₊₁|sₜ, uₜ), and a reward value, r(sₜ, uₜ), may be defined for each action, uₜ, and state, sₜ. The expressions and variables described herein may define a dynamic control problem. For example, for each user at the start of a day a plurality of predictive activity sequences may be sampled. Such predictive activity sequences may represent predictions (e.g., personalized predictions) of what activities (e.g., what activity durations) may be performed by the user if no intervention is issued (e.g., if the user is not prompted to perform activities).

One or more activity probabilities may be generated (e.g., by a machine learning model) for one or more activity subgoals of a personalized activity sequence. For example, p(sₜ₊₁|sₜ), may be estimated (e.g., at time t). If the user has already done sₜ, p(sₜ₊₁|sₜ) may indicate a probability of the user performing sₜ₊₁ amount of activity at time, t+1. This estimate may be computable from a previously sampled sequence, since pairs of (sₜ, sₜ₊₁) have been determined for each time, t.

In some embodiments, the activity probability is a value indicating a likelihood that a user will complete an activity subgoal. An activity probability may be expressed as a relative value, such as a percentage, ratio, proportion, and/or the like. In some examples, an activity probability may correspond each of one or more activity subgoals for a user. By way of example, an activity probability for an activity subgoal of 5 minutes of MPA during a first time segment of an evaluation time period may be 95% indicating that a user may have a 95% likelihood of completing 5 minutes of MPA during a first time segment.

An augmented (e.g., adjusted) version of p (sₜ₊₁|sₜ) may be defined as p(sₜ₊₁|sₜ, uₜ). Since p(sₜ₊₁|sₜ) is a user's usual behavior without intervention, a change in the user's behavior is expected if an intervention is suggested. As described herein, small, realistic changes may be suggested. In some examples, different values of small changes, uₜ, may be generated to determine a suggestion. In some examples, a standard deviation of p(sₜ₊₁|sₜ) may be increased (e.g., by 1.5 times) and a new (e.g., adjusted) distribution may be formed. The new distribution may be referred to as augmented p(sₜ₊₁|sₜ). The augmented (e.g., new) distribution may be sampled and a change, uₜ, may be made as the difference of the sampled value and sₜ. Effectively, such operations, sample more broadly than what a user performed in the past. The broader sampling is the result of sampling from the augmented p(sₜ₊₁|sₜ). Increasing the standard deviation by a relatively small amount (e.g., 1.5 times) may result in sampled activity durations within a realistic range that is achievable for a user. Sampling from the augmented p(sₜ₊₁|uₜ, sₜ) may enable exploration and off-policy learning. The augmented p(sₜ₊₁|sₜ) may be defined as p(sₜ₊₁|sₜ, uₜ).

In some embodiments, a reward value, r(sₜ, uₜ), is defined for each activity subgoal of a personalized activity sequence. In some examples, the reward value, r(sₜ, uₜ), may be the change, uₜ, itself, unless sₜ>g, indicating that activities resulting in an activity threshold being exceeded are recommended, in which case a negative reward results. The negative reward may penalize overreaching the activity threshold. Once the problem is defined, the problem may be solved, resulting in a sequence of uₜ, for each of the k time segments. Since s₁ is typically zero (e.g., the user has not performed an activity), uₜ can be used to generate one or more sₜ's. From the one or more sₜ's, one or more xₜ's may be generated. Once xₜ's are defined, a personalized activity sequence may be [x₁+u₁, x₂+u₂, x₃+u₃, . . . , x_{K}+u_{K}]. If the activity subgoals of the personalized activity sequence do not sum to an activity threshold (e.g., a daily goal, etc.), the remaining activity subgoals to achieve the activity threshold may be equally distributed to non-zero subgoals.

In some embodiments, the reward value is a value or a quantity that indicates a difference between an activity subgoal and a corresponding activity prediction (e.g., an upper bound of an activity prediction, a lower bound of an activity prediction, etc.). For example, if an activity subgoal is greater than a corresponding activity prediction for a respective time segment (e.g., an activity subgoal of 15 minutes of MPA and an activity prediction of 5 to 10 minutes of MPA), a corresponding reward value may be positive (e.g., a reward value of 5). If an activity subgoal is less than a corresponding activity prediction for a respective time segment (e.g., an activity subgoal of 3 minutes of MPA and an activity prediction of 5 to 10 minutes of MPA), a corresponding reward value may be negative (e.g., a reward value of negative 2). In some examples, the difference between the activity subgoal and the corresponding activity prediction may be referred to as a degree or extent to which the activity subgoal is greater than or less than the respective activity prediction.

In some embodiments, the process 400 includes, at step/operation 415, providing one or more notifications. For example, a system may generate one or more activity notifications for a user. Each activity notification may correspond to respective activity subgoal of a personalized activity sequence. In some examples, an activity notification may be provided to a user at a time corresponding to an activity segment associated with a respective activity subgoal.

For example, at a same time (or within a threshold of the time) that an activity subgoal is generated (e.g., generated, determined, selected), an activity notification (e.g., data indicative of an activity subgoal) may be provided to a user, via a user interface, which may remind the user to perform an activity corresponding to the activity subgoal. In such cases, the activity notification may initiate performance of the activity by the user during an activity time segment in which the user is most likely to perform the activity. For example, the user may receive the activity notification and may perform a duration of an activity based on receiving the activity notification.

In some embodiments, an activity notification includes information notifying a user to complete the subgoal. Completing the subgoal may include performing an activity for a duration indicated by an activity subgoal of a personalized activity sequence. The activity notification may be included in a message that is provided to a user device, such as a wearable device (e.g., a smartwatch), a handheld device (e.g., smartphone, etc.), and/or the like. In some examples, a user may also be provided with a goal notification to achieve an activity threshold (e.g., an overarching activity goal). A goal notification may be provided with the activity notification and/or independently of the activity notification. Additionally, or alternatively, a user may be provided with a status notification indicating a status of an activity subgoal, an activity threshold, and/or the like.

In some examples, an activity notification may include a control signal that may be transmitted to a device of the user (e.g., a smartwatch, a smartphone, a fitness tracker), which may cause the device to vibrate, emit an audio signal, or both. In some examples, the control signal may be transmitted at the same time that subgoals are recommended, or prior to the recommendation of activity subgoals. In some examples, a notification or other data provided to a user may cause the administration of a treatment. For example, the notification may cause a user to take a drug, take a supplement, consume a food, consume a beverage, perform a physical therapy exercise, or any other type of activity that may be performed to treat a health condition of the user. The following description may provide an illustrative example of the techniques described herein for an MPA goal of 30 minutes per day.

Consider an office worker who commutes in the morning and afternoon. The morning commute may include a longer walk (e.g., 17-19 MPA minutes) when compared to the afternoon commute, which may include a walk of 3-7 MPA minutes. An activity prediction may be generated (e.g., by the machine learning model) that the user completes 17-19 MPA minutes between an activity time segment of 6-9 a.m. and 3-7 MPA minutes between an activity time segment of 6-9 p.m. A personalized activity sequence may be sampled that includes 19 minutes between 6-9 a.m. and 7 minutes between 6-9 p.m. The personalized activity sequence may sum to 26 minutes and may be closest to the 30-minute goal, when compared to other predictive activity sequences. To the contrary, a predictive activity sequence with 17 minutes between 6-9 a.m. and 6 minutes between 6-9 p.m. may not be sampled (e.g., because the activity sequence sums to 23 minutes and there may be an activity sequence of 26 minutes that is closer to the 30-minute goal). The personalized activity sequence that sums to 26 minutes (e.g., 19 MPA minutes between 6-9 a.m. and 7 MPA minutes between 6-9 p.m.) may be 4 minutes short of the 30-minute goal. Accordingly, the system may add a reward value of 2 minutes to the morning activity subgoal and 2 minutes to the afternoon activity subgoal (e.g., suggesting 21 (=19+2) minutes between 6-9 a.m. and 9 (=7+2) minutes between 6-9 p.m. The resulting 21 and 9 minute subgoals sum to the 30-minute daily activity threshold.

An activity notification may be provided to a user, via a user interface, before, during, and/or after an activity time segment including each of the activity subgoals. In some examples, the techniques described herein for determining a personalized activity sequence may be performed periodically. For example, the techniques described herein may be performed every day at midnight. The model may generate a subgoal, for example, between 3-4 p.m. The model may determine to notify the user of the subgoal at 3 p.m. or before 3 p.m. In some other cases, determinations for whether to send activity notifications may be randomized. In such cases, the machine learning model may learn which notification timings are most effective and may subsequently utilize the notification timings determined to be most effective.

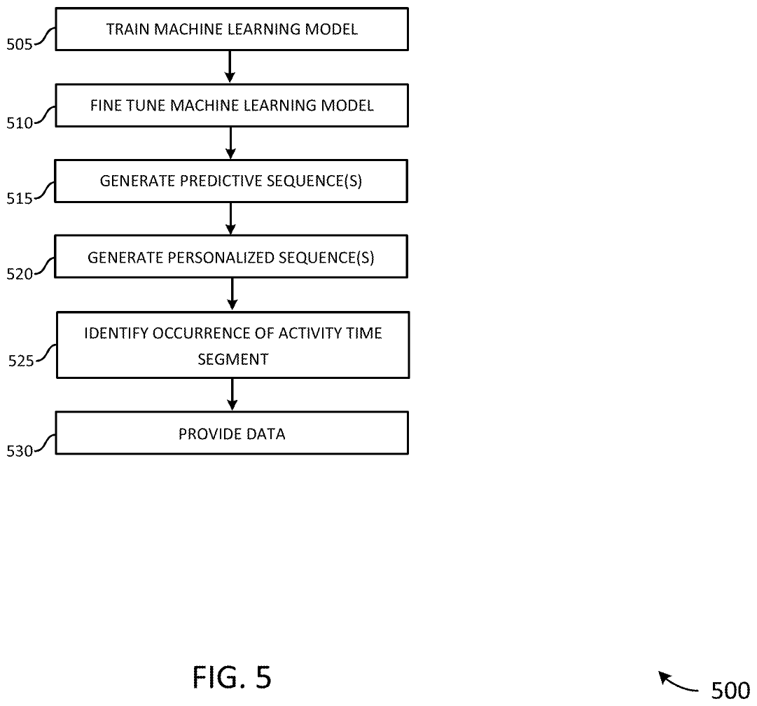

FIG. 5 illustrates an example process 500 for explanatory purposes. Although the example process 500 depicts a particular sequence of steps/operations, the sequence may be altered without departing from the scope of the present disclosure. For example, some of the steps/operations depicted may be performed in parallel or in a different sequence that does not materially impact the function of the process 500. In other examples, different components of an example device or system that implements the process 500 may perform functions at substantially the same time or in a specific sequence.

In some embodiments, the process 500 includes, at step/operation 505, training a machine learning model. The machine learning model may receive one or more training samples from a training dataset associated with a plurality of training users. The training dataset may include a plurality of historical activity durations corresponding to each of the plurality of training users. A historical activity duration for a particular training user, for example, may include activity data, health data (e.g., comorbidity information, etc.), demographic data (e.g., age attribute, gender attributes, etc.), contextual data (e.g., contextual factors, etc.), or any other information associated with a duration of activity and/or the particular training user that previously engaged in the duration of activity. In some examples, contextual factors may include one or more factors or parameters that influence an ability of a user to complete a task, a goal, or a subgoal. For example, weather or climate may be an example of a contextual factor. A time of day, a day of the week, and a location may also be examples of contextual factors. In some examples, contextual factors may include information for a current time or information that corresponds to a time period. For example, weather information may include current weather information or historical weather information.

The activity data, for example, may indicate a type of activity. The health data may indicate one or more health metrics for a particular user, such as one or more clinical diagnoses, and/or the like. The contextual data may indicate one or more contextual factors corresponding to activity durations, such as one or more weather attributes (e.g. raining, snowing, sunny, temperature ranges, etc.), location attributes (e.g. a geographical location, a relative location, such as a gym, home, etc.), time attributes (e.g., a time of day, a duration of the activity, etc.), and/or the like.

In some embodiments, the machine learning model is trained using the one or more training samples from a training dataset associated with a plurality of training users. For example, the machine learning model may be trained using back-propagation of errors, gradient descent, and/or the like, to generate one or more predictive activity sequences for a user based on historical activity sequences observed for a population of users.

In some embodiments, the process 500 includes, at step/operation 510, fine-tuning the machine learning model. In some examples, fine-tuning the machine learning model may include tuning the machine learning model for a particular user (e.g., a user of the plurality of training users, etc.) within the plurality of users. The machine learning model, for example, may be fine tuned using a portion of the training dataset that corresponds to the particular user. By way of example, the portion of the training data may include a plurality of historical user-specific activity durations corresponding to the particular user.

In some embodiments, the machine learning model is fine-tuned using the plurality of historical user-specific activity durations from a training dataset. For example, the machine learning model may be trained using back-propagation of errors, gradient descent, and/or the like, to generate one or more predictive activity sequences specific to a particular user based on historical activity sequences observed for the particular user.

In some embodiments, the process 500 includes, at step/operation 515, generating one or more predictive activity sequences for the particular user. Generating the one or more predictive activity sequences may include generating a plurality of activity predictions. Each activity prediction may be a value or a range of values that indicate an amount of time or a range of times that the particular user is expected to spend performing or otherwise engaging in an activity. The one or more predictive activity sequences may be generated by the machine learning model.

In some embodiments, the process 500 includes, at step/operation 520, generating one or more personalized activity sequences for the particular user. For example, the one or more personalized activity sequences may be generated by generating a plurality of activity subgoals. Each activity subgoal of a personalized activity sequence may include a value that indicates an amount of time a user may spend performing an activity to satisfy an activity threshold. For example, the personalized activity sequence may include a set of recommended behaviors (e.g., activity durations, subgoals, etc.) for achieving an activity threshold.

In some embodiments, the process 500 includes, at step/operation 525, identifying an occurrence of an activity time segment. For example, the system may identify that a current time is equivalent to an initial time of an activity time segment. In addition, or alternatively, the system may identify the occurrence of the activity time segment prior to the activity time segment. For example, the system may identify that an activity time segment is about to occur (e.g., that a current time is within a range of a start time for the activity time segment). As described herein, an activity time segment may be an example of a duration that corresponds to an activity s goal of a personalized activity sequence, and/or the like.

In some embodiments, the process 500 includes, at step/operation 530, providing data. For example, the system may transmit a signal to a user device that indicates the personalized activity sequence or one or more recommended activities (e.g., one or more subgoals, etc.) of a personalized activity sequence. The data may be included in an activity notification and may indicate one or more activities for the user to perform during an activity time segment of an evaluation time period. In some examples, the data may initiate performance of the one or more activities by the user. For example, the user may receive the data and may perform a duration of an activity based on receiving the data. Additionally, or alternatively, a control signal may be transmitted to a device of the user (e.g., a smartwatch, a smartphone, a fitness tracker) to control the device to perform a tactile (e.g., vibration, etc.), audio (e.g., emit an audio signal, etc.) and/or the like signal to initiate the performance of the one or more activities by the user at a particular time.

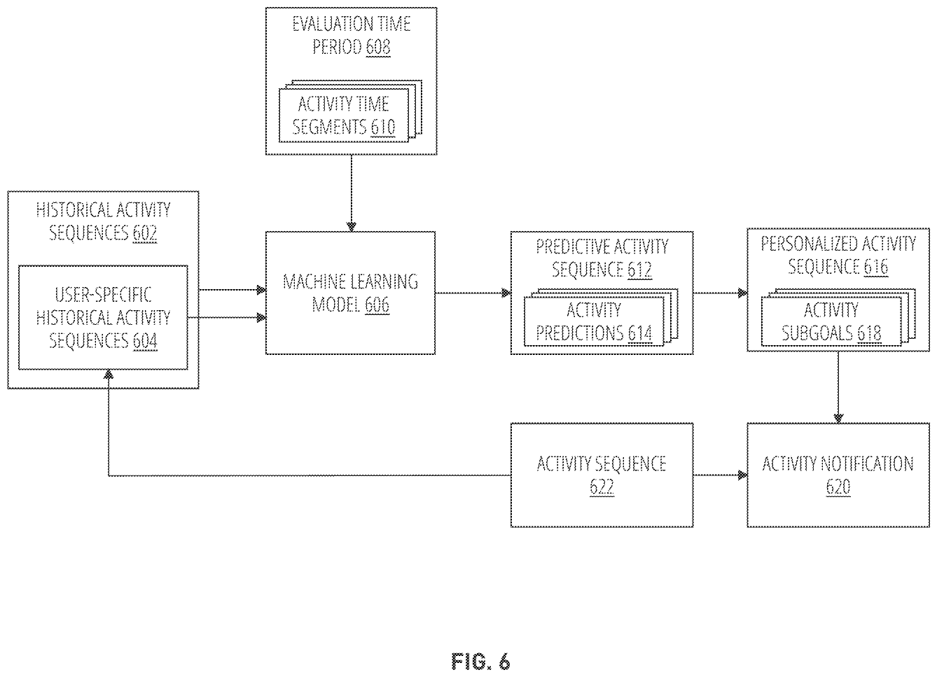

FIG. 6 illustrates an example data flow diagram 600 for explanatory purposes. The data flow diagram 600 may provide one illustrative example of data that is input to and output by a machine learning model 606. Although the example data flow diagram 600 depicts a particular data flow, the data flow may be altered without departing from the scope of the present disclosure. For example, one or more activity sequences shown as being output by the machine learning model 606 may additionally or alternatively be input to the machine learning model 606 (e.g., the machine learning model 606 may be trained using information that was previously output).

In some embodiments, a predictive activity sequence 612 is generated for a user using a machine learning model 606. The predictive activity sequence 612 may include a plurality of activity predictions 614 corresponding to a plurality of activity time segments 610 within an evaluation time period 608. In some examples, the predictive activity sequence 612 is based on one or more contextual factors corresponding to the user. In some examples, a number of the plurality of activity time segments 610 is based on a type of activity associated with the personalized activity sequence.

In some embodiments, a predictive activity sequence 612 is a predicted activity sequence 622 for an evaluation time period 608. The data elements of a predictive activity sequence 612 may include a plurality of activity predictions 614. Each activity prediction may represent a static and/or probabilistic amount (and/or range) of time that a user is expected to spend performing or otherwise engaging in an activity.

In some embodiments, a predictive activity sequence 612 is an output of a machine learning model 606. In some examples, the machine learning model 606 may be tailored to a user to generate a predictive activity sequence 612 that is learned from historical activity patterns of the user. As an illustrative example, a predictive activity sequence 612 for moderate physical activity (MPA) may include five activity predictions 614 respectively corresponding to five time segments within an evaluation time period 608 of a day. Each activity prediction may include a range of values. For example, a first activity prediction may include a first value (e.g., 10 minutes) and a second value (e.g., 15 minutes) indicating that a user is likely to perform 10 to 15 minutes of MPA during a time segment corresponding to the first activity prediction. A predictive activity sequence 612 may include an individual activity prediction for each of the time segments within the evaluation time period 608.

In some embodiments, the activity sequence 622 is one or more data elements associated with a time period. Each data element, for example, may represent an activity duration during the time period. For instance, a data element may include one or more values (and/or a range of values) that represent an amount of time and a corresponding activity. A data element, for example, may correspond to a type of activity, such as walking, jogging, running, cycling, reading, meditation, breathing exercises, and/or the like and a duration of time during which a user engages in the type of activity.

In some examples, each data element of an activity sequence 622 may correspond to a time segment within a time period, such as an evaluation time period 608 as described herein. The time period may include any unit of measurement for measuring a duration of time. In some examples, the time period may be configurable for a user and/or a predictive output for a user. By way of example, a time period may include one or more minutes, hours, days, weeks, months, years, and/or the like. In some examples, an activity sequence 622 may include one or more data elements for each of one or more time segments within the time period. By way of example, in the event that the time period is a single day, the single day may be divided into a first time segment between 12:01 a.m. to 6:00 a.m., a second time segment between 6:00 a.m. to 12:01 p.m., a third time segment between 12:01 p.m. to 6:00 p.m., a fourth time segment between 6:00 p.m. to 12:01 a.m., and/or the like. In such a case, an activity sequence 622 may include one or more data elements that indicate an amount of time that a user performs a particular activity during the first, second, third, and fourth time segments.

In some embodiments, an evaluation time period 608 is a duration (e.g., an amount of time) corresponding to a predictive activity sequence 612 and/or a personalized activity sequence. For example, an evaluation time period 608 may include one or more activity time segments 610. A predictive activity sequence 612 and/or a personalized activity sequence 616 may include one or more data elements (e.g., an activity prediction, an activity subgoal, etc.) that correspond to each activity time segment of the evaluation time period 608. By way of example, an evaluation time period 608 may be a single day with five activity time segments 610.

In some embodiments, an activity time segment is a time segment (e.g., a duration, a time period, etc.) within an evaluation time period 608. An evaluation time period 608 may include a plurality of activity time segments 610. By way of example, an evaluation time period 608 may include a day (e.g., a 24-hour time period) that may be divided into a plurality daily time segments, such as a first activity time segment between 6:00 a.m. to 9:00 a.m., a second activity time segment between 9:00 a.m. to 12:00 p.m., a third activity time segment between 12:00 p.m. to 3:00 p.m., a fourth activity time segment between 3:00 p.m. to 6:00 p.m., and/or the like. In some examples, an evaluation time period 608 may include activity time segments 610 that span the entire evaluation time period 608. In addition, or alternatively, an evaluation time period 608 may include activity time segments 610 that span a portion of the evaluation time period 608. In some examples, each activity time segment in an evaluation time period 608 may include an equal time duration (e.g., three hours, etc.). In addition, or alternatively, two or more activity time segments 610 may include different time durations.

In some embodiments, the machine learning model 606 includes an encoder-decoder network previously trained using a plurality of historical activity sequences 602 for a cohort of users. In some examples, the machine learning model 606 may be fine-tuned using one or more user-specific historical activity sequences 604 of the plurality of historical activity sequences 602 that correspond to the user.

In some embodiments, the machine learning model 606 is a data entity that describes parameters, hyper-parameters, and/or defined operations of a rules-based and/or machine learning model 606 (e.g., model including at least one of one or more rule-based layers, one or more layers that depend on trained parameters, coefficients, and/or the like). A machine learning model 606 may include one or more machine learning model 606s configured, trained (e.g., jointly, separately, etc.), and/or the like to generate one or more predictive outputs, such as predictive activity sequences, for one or more users within a population of users. A machine learning model 606 may include one or more of any type of machine learning model 606 including one or more supervised, unsupervised, semi-supervised, reinforcement learning models, and/or the like. In some examples, a machine learning model 606 may include multiple models configured to perform one or more different stages of a prediction process.

In some embodiments, a machine learning model 606 includes a natural language processing (NLP) model. A machine learning model 606, for example, may include an encoder-decoder network. The encoder-decoder network may include one or more encoder models and/or one or more decoder models. In some examples, the one or more encoder and/or decoder models, for example, may include one or more neural networks, such as recurrent neural networks, convolutional neural networks, and/or the like. In some examples, one or more encoder models may be trained to generate one or more latent activity representations (e.g., lower-dimensional embeddings, etc.) for a user that represents general activity patterns for the user. The one or more decoder models may be trained to generate a predictive activity sequence 612 for a user during an evaluation time period 608 based on the one or more latent activity representations.

In some embodiments, a machine learning model 606 is trained, using one or more supervisory training techniques, using a training dataset. The training dataset, for example, may include a plurality of historical activity durations for a plurality of users within a population of users. In some examples, a machine learning model 606 may be initially trained on the training dataset and then fine-tuned on a portion of the training dataset, for example, to personalize the machine learning model 606 for a particular user associated with a subset of the historical activity durations.

In some embodiments, a personalized activity sequence 616 is generated for the user based on the predictive activity sequence. The personalized activity sequence 616 may include a plurality of activity subgoals 618 corresponding to one or more activity time segments 610 of the plurality of activity time segments 610 within the evaluation time period 608. In some examples, an activity subgoal for a respective activity time segment may be generated based on an activity prediction of the plurality of activity predictions 614 that corresponds to the respective activity time segment. For example, the activity subgoal may be selected from the plurality of activity predictions 614. In addition, or alternatively, the personalized activity sequence 616 may include a predictive activity sequence 612 that is augmented with one or more reward values. A reward value of the one or more reward values may indicate a degree to which the activity subgoal exceeds the activity prediction.

In some embodiments, the personalized activity sequence 616 is a recommended activity sequence 622 for a user during an evaluation time period 608. The data elements of a personalized activity sequence 616 may include a plurality of activity subgoals 618. Each activity subgoal may represent a defined amount (and/or range) of time that a user may spend performing and/or otherwise engaging in an activity to achieve an activity threshold (e.g., a health goal, etc.) for an evaluation time period 608. For example, the personalized activity sequence 616 may include a set of recommended behaviors (e.g., activity durations, subgoals, etc.) for achieving an activity threshold.

In some embodiments, a personalized activity sequence 616 is based on a predictive activity sequence 612 for a user. For example, an activity subgoal of a personalized activity sequence 616 may include a value that is selected from one or more activity predictions 614 from one or more predictive activity sequences generated for a user. For instance, if a predictive activity sequence 612 has a first element indicating that a user is likely to perform 10 to 15 minutes of MPA, a corresponding personalized activity sequence 616 for the user may have a first element that indicates 10 minutes of MPA, 11 minutes of MPA, or any other duration of MPA included in the predicted range. In some other cases, a personalized activity sequence 616 may include elements selected from outside of a range of values indicated by a respective element of a predictive activity sequence, as described in further detail herein. In some examples, each element of a personalized activity sequence 616 may be referred to as a subgoal.

In some embodiments, the activity subgoal is a duration of an activity that is recommended for a user. A duration of an activity may correspond to a particular activity time segment within an evaluation time period 608. Completing one or more activity subgoals 618 within an evaluation time period 608 may result in the completion (and/or near completion) of an activity threshold. An activity subgoal may be selected from one or more activity predictions 614 included in one or more predictive activity sequences for an evaluation time period 608. By way of example, an activity subgoal is 5 minutes of MPA (e.g., between 6:00 a.m. and 9:00 a.m.).

In some embodiments, the activity threshold is an amount of activity during an evaluation time period 608. For example, an activity threshold may describe a personal activity goal, such as a health goal, a productivity goal, a fitness goal, and/or the like, of a user during an evaluation time period 608. The activity threshold may be represented as a duration of time, a particular activity, and/or one or more expected results from performing a particular activity for a duration of time (e.g., calories burned, etc.). As an example, an activity threshold may include a daily activity goal for a user, such as 30 minutes of daily activity (e.g., walking, running, etc.) within an evaluation time period 608 of 24 hours. By way of example, an activity threshold may include completing thirty minutes of walking per day, completing three hours of running per week, performing forty hours of work per week, and/or the like.

In some embodiments, an activity threshold is generated by a machine learning model 606. In addition, or alternatively, an activity threshold may be selected by a user. In some examples, an activity threshold may be initially selected by a user and the machine learning model 606 may adjust the activity threshold, such that that a likelihood of completion is higher for the adjusted activity threshold when compared to the activity threshold initially selected by the user. In some examples, completing one or more subgoals during an evaluation period may result in completion of the activity threshold.

In some embodiments, the reward value is a value or a quantity that indicates a difference between an activity subgoal and a corresponding activity prediction (e.g., an upper bound of an activity prediction, a lower bound of an activity prediction, etc.). For example, if an activity subgoal is greater than a corresponding activity prediction for a respective time segment (e.g., an activity subgoal of 15 minutes of MPA and an activity prediction of 5 to 10 minutes of MPA), a corresponding reward value may be positive (e.g., a reward value of 5). If an activity subgoal is less than a corresponding activity prediction for a respective time segment (e.g., an activity subgoal of 3 minutes of MPA and an activity prediction of 5 to 10 minutes of MPA), a corresponding reward value may be negative (e.g., a reward value of negative 2). In some examples, the difference between the activity subgoal and the corresponding activity prediction may be referred to as a degree or extent to which the activity subgoal is greater than or less than the respective activity prediction.

In some embodiments, an occurrence of an activity time segment is identified. The occurrence of the activity time segment may be identified prior to (e.g., a threshold time, such as one or more minutes, etc.), during, and/or after the activity time segment. In some examples, the activity time segment may correspond to an activity subgoal of the plurality of activity subgoals 618.

In some embodiments, in response to the occurrence of the activity time segment, data indicative of the activity subgoal may be provided to a user. The data indicative of the activity subgoal, for example, may include an activity notification 620. In some examples, the data indicative of the activity subgoal is provided prior to the activity time segment.

In some embodiments, the activity notification 620 includes information notifying a user to complete the subgoal. Completing the subgoal may include performing an activity for a duration indicated by an activity subgoal of a personalized activity sequence. The activity notification 620 may be included in a message that is provided to a user device, such as a wearable device (e.g., a smartwatch), a handheld device (e.g., smartphone, etc.), and/or the like. In some examples, a user may also be provided with a goal notification to achieve an activity threshold (e.g., an overarching activity goal). A goal notification may be provided with the activity notification 620 and/or independently of the activity notification 620. Additionally, or alternatively, a user may be provided with a status notification indicating a status of an activity subgoal, an activity threshold, and/or the like.

In some embodiments, an activity sequence 622 may be received (e.g., via sensor data, user input, etc.) for the evaluation time period 608. In some examples, in response to the activity sequence, one or more parameters of the machine learning model 606 may be updated. By way of example, the historical activity sequences 602 may be updated to include the activity sequence. The one or more parameters of the machine learning model 606 may be updated through one or more retraining operations using the updated historical activity sequences 602.

Some of the techniques of the present disclosure result in the real time and automatic provision of a personalized activity sequence 622 (e.g., one or more activity sequences) for achieving an activity threshold to a user. Some of the techniques of the present disclosure may include automatic determination of the personalized activity sequence 616 (e.g., without user input). Additionally, or alternatively, some of the techniques of the present disclosure divide an activity threshold into smaller, more manageable, time-bound activity subgoals 618, which may reduce procrastination (e.g., completing subgoals may be perceived as less challenging than completing one goal for an entire day). Each activity subgoal may be personalized and may reflect a user's own behavior, which may improve a likelihood that subgoals are completed. Additionally, or alternatively, providing activity notifications of subgoals may increase a likelihood that a user completes the subgoals.

Although some operations described herein may be performed independently, any of the operations described herein may be performed in combination. For example, some of the techniques of the present disclosure may predict activity sequences based on historical data, modify the predicted activity sequences to achieve an activity threshold, and provide a personalized activity sequence 622 to a user that includes performing the modified activity sequence. The techniques described herein may utilize improved generative artificial intelligence modelling techniques to predict ranges and times of daily activities to generate a personalized activity sequence 622 for a user. The personalized activity sequence 616 may be leveraged to intelligently suggest intermediate activity subgoals 618 that, when completed by a user, result in the completion of an activity threshold (e.g., an overarching goal). In some examples, a dynamic control algorithm may be used to optimize activity subgoals 618. For example, the some of the techniques of the present disclosure may solve one or more dynamic control problems to determine or otherwise generate activity subgoals 618 for a user. In some examples, an activity notification (e.g., a suggestion, a message, etc.) may be proactively provided to a user relative to a time segment that includes an activity subgoal. Providing proactive notifications for subgoals may provide advantages when compared to traditional activity tracking techniques, as described herein.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method, the computer-implemented method comprising generating, by one or more processors and using a machine learning model, a predictive activity sequence for a user that comprises a plurality of activity predictions corresponding to a plurality of activity time segments within an evaluation time period; generating, by the one or more processors and based on the predictive activity sequence, a personalized activity sequence for the user that comprises a plurality of activity subgoals corresponding to one or more activity time segments of the plurality of activity time segments within the evaluation time period; identifying, by the one or more processors, an occurrence of an activity time segment corresponding to an activity subgoal of the plurality of activity subgoals; and in response to the occurrence of the activity time segment, providing, by the one or more processors, data indicative of the activity subgoal.

Example 2. The computer-implemented method of example 1, wherein the machine learning model comprises an encoder-decoder network previously trained using a plurality of historical activity sequences for a cohort of users.

Example 3. The computer-implemented method of example 2, wherein the machine learning model is fine-tuned using one or more user-specific historical activity sequences of the plurality of historical activity sequences that correspond to the user.

Example 4. The computer-implemented method of example 3, further comprising: receiving an activity sequence for the evaluation time period; and in response to the activity sequence, updating one or more parameters of the machine learning model.

Example 5. The computer-implemented method of example 1, wherein the activity subgoal is generated based on an activity prediction of the plurality of activity predictions that corresponds to the activity time segment.

Example 6. The computer-implemented method of example 5, wherein the personalized activity sequence comprises the predictive activity sequence that is augmented with one or more reward values and a reward value of the one or more reward values indicates a degree to which the activity subgoal exceeds the activity prediction.

Example 7. The computer-implemented method of example 1, wherein the activity subgoal is selected from the plurality of activity predictions.

Example 8. The computer-implemented method of example 1, wherein the predictive activity sequence is based on one or more contextual factors corresponding to the user.

Example 9. The computer-implemented method of example 1, wherein a number of the plurality of activity time segments is based on a type of activity associated with the personalized activity sequence.

Example 10. The computer-implemented method of example 1, wherein the data indicative of the activity subgoal is provided prior to the activity time segment.

Example 11. A computing system, the computing system comprising memory and one or more processors communicatively coupled to the memory, the one or more processors configured to generate, using a machine learning model, a predictive activity sequence for a user that comprises a plurality of activity predictions corresponding to a plurality of activity time segments within an evaluation time period; generate, based on the predictive activity sequence, a personalized activity sequence for the user that comprises a plurality of activity subgoals corresponding to one or more activity time segments of the plurality of activity time segments within the evaluation time period; identify, an occurrence of an activity time segment corresponding to an activity subgoal of the plurality of activity subgoals; and in response to the occurrence of the activity time segment, provide data indicative of the activity subgoal.

Example 12. The computing system of example 11, wherein the machine learning model comprises an encoder-decoder network previously trained using a plurality of historical activity sequences for a cohort of users.

Example 13. The computing system of example 12, wherein the machine learning model is fine-tuned using one or more user-specific historical activity sequences of the plurality of historical activity sequences that correspond to the user.

Example 14. The computing system of example 13, wherein the one or more processors are further configured to receive an activity sequence for the evaluation time period; and in response to the activity sequence, update one or more parameters of the machine learning model.

Example 15. The computing system of example 11, wherein the activity subgoal is generated based on an activity prediction of the plurality of activity predictions that corresponds to the activity time segment.

Example 16. The computing system of example 15, wherein the personalized activity sequence comprises the predictive activity sequence that is augmented with one or more reward values and a reward value of the one or more reward values indicates a degree to which the activity subgoal exceeds the activity prediction.

Example 17. The computing system of example 11, wherein the activity subgoal is selected from the plurality of activity predictions.

Example 18. The computing system of example 11, wherein the predictive activity sequence is based on one or more contextual factors corresponding to the user.

Example 19. The computing system of example 11, wherein a number of the plurality of activity time segments is based on a type of activity associated with the personalized activity sequence.

Example 20. One or more non-transitory computer-readable storage media including instructions that, when executed by one or more processors, cause the one or more processors to generate, using a machine learning model, a predictive activity sequence for a user that comprises a plurality of activity predictions corresponding to a plurality of activity time segments within an evaluation time period; generate, based on the predictive activity sequence, a personalized activity sequence for the user that comprises a plurality of activity subgoals corresponding to one or more activity time segments of the plurality of activity time segments within the evaluation time period; identify, an occurrence of an activity time segment corresponding to an activity subgoal of the plurality of activity subgoals; and in response to the occurrence of the activity time segment, provide data indicative of the activity subgoal.

1. A computer-implemented method, comprising:
generating, by one or more processors and using a machine learning model, a predictive activity sequence for a user that comprises a plurality of activity predictions corresponding to a plurality of activity time segments within an evaluation time period;
generating, by the one or more processors and based on the predictive activity sequence, a personalized activity sequence for the user that comprises a plurality of activity subgoals corresponding to one or more activity time segments of the plurality of activity time segments within the evaluation time period;
identifying, by the one or more processors, an occurrence of an activity time segment corresponding to an activity subgoal of the plurality of activity subgoals; and
in response to the occurrence of the activity time segment, providing, by the one or more processors, data indicative of the activity subgoal.

2. The computer-implemented method of claim 1, wherein the machine learning model comprises an encoder-decoder network previously trained using a plurality of historical activity sequences for a cohort of users.

3. The computer-implemented method of claim 2, wherein the machine learning model is fine-tuned using one or more user-specific historical activity sequences of the plurality of historical activity sequences that correspond to the user.

4. The computer-implemented method of claim 3, further comprising:
receiving an activity sequence for the evaluation time period; and
in response to the activity sequence, updating one or more parameters of the machine learning model.

5. The computer-implemented method of claim 1, wherein the activity subgoal is generated based on an activity prediction of the plurality of activity predictions that corresponds to the activity time segment.

6. The computer-implemented method of claim 5, wherein the personalized activity sequence comprises the predictive activity sequence that is augmented with one or more reward values and a reward value of the one or more reward values indicates a degree to which the activity subgoal exceeds the activity prediction.

7. The computer-implemented method of claim 1, wherein the activity subgoal is selected from the plurality of activity predictions.

8. The computer-implemented method of claim 1, wherein the predictive activity sequence is based on one or more contextual factors corresponding to the user.

9. The computer-implemented method of claim 1, wherein a number of the plurality of activity time segments is based on a type of activity associated with the personalized activity sequence.

10. The computer-implemented method of claim 1, wherein the data indicative of the activity subgoal is provided prior to the activity time segment.

11. A computing system comprising memory and one or more processors communicatively coupled to the memory, the one or more processors configured to:
generate, using a machine learning model, a predictive activity sequence for a user that comprises a plurality of activity predictions corresponding to a plurality of activity time segments within an evaluation time period;
generate, based on the predictive activity sequence, a personalized activity sequence for the user that comprises a plurality of activity subgoals corresponding to one or more activity time segments of the plurality of activity time segments within the evaluation time period;
identify an occurrence of an activity time segment corresponding to an activity subgoal of the plurality of activity subgoals; and
in response to the occurrence of the activity time segment, provide data indicative of the activity subgoal.

12. The computing system of claim 11, wherein the machine learning model comprises an encoder-decoder network previously trained using a plurality of historical activity sequences for a cohort of users.

13. The computing system of claim 12, wherein the machine learning model is fine-tuned using one or more user-specific historical activity sequences of the plurality of historical activity sequences that correspond to the user.

14. The computing system of claim 13, wherein the one or more processors are further configured to:
receive an activity sequence for the evaluation time period; and
in response to the activity sequence, update one or more parameters of the machine learning model.

15. The computing system of claim 11, wherein the activity subgoal is generated based on an activity prediction of the plurality of activity predictions that corresponds to the activity time segment.

16. The computing system of claim 15, wherein the personalized activity sequence comprises the predictive activity sequence that is augmented with one or more reward values and a reward value of the one or more reward values indicates a degree to which the activity subgoal exceeds the activity prediction.

17. The computing system of claim 11, wherein the activity subgoal is selected from the plurality of activity predictions.

18. The computing system of claim 11, wherein the predictive activity sequence is based on one or more contextual factors corresponding to the user.

19. The computing system of claim 11, wherein a number of the plurality of activity time segments is based on a type of activity associated with the personalized activity sequence.

20. One or more non-transitory computer-readable storage media including instructions that, when executed by one or more processors, cause the one or more processors to:
generate, using a machine learning model, a predictive activity sequence for a user that comprises a plurality of activity predictions corresponding to a plurality of activity time segments within an evaluation time period;
generate, based on the predictive activity sequence, a personalized activity sequence for the user that comprises a plurality of activity subgoals corresponding to one or more activity time segments of the plurality of activity time segments within the evaluation time period;
identify an occurrence of an activity time segment corresponding to an activity subgoal of the plurality of activity subgoals; and
in response to the occurrence of the activity time segment, provide data indicative of the activity subgoal.
